(19) United States
(12) Patent Application Publication
(10) Pub. No.: US 2026/0051987 A1
(43) Pub. Date: Feb. 19, 2026

(54) SUB-BAND DISCRETE FOURIER TRANSFORM-SPREAD-ORTHOGONAL FREQUENCY DIVISION MULTIPLEXING FOR DOWNLINK

(71) Applicant: Lenovo (Singapore) Pte. Limited, Singapore (SG)

(72) Inventors: Ali Ramadan Ali, Kraiburg (DE); Karthikeyan Ganesan, Kronberg Im Taunus (DE)

(73) Assignee: Lenovo (Singpore) Pte. Limited, Singapore (SG)

(21) Appl. No.: 18/807,686

(22) Filed: Aug. 16, 2024

(51) Int. Cl. H04L 5/00; H04L 27/26

(52) U.S. Cl. CPC H04L 5/0048; H04L 5/0007; H04L 5/0039; H04L 5/0094; H04L 27/2627

(57) ABSTRACT

Various aspects of the present disclosure relate to sub-band discrete Fourier transform-spread-orthogonal frequency division multiplexing for downlink. An apparatus, such as a user equipment (UE), receives signaling comprising a configuration for common Discrete Fourier Transform (DFT) spreading length of a DFT-s-OFDM waveform, the common DFT spreading length configured for a common sub-band generated using contiguous frequency domain resource blocks for a group of UEs. The UE receives a DFT-s-OFDM waveform over at least one of common channel, control channel, or data channel within the common sub-band and according to the common DFT spreading length of the DFT-s-OFDM waveform.

### TECHNICAL FIELD

The present disclosure relates to wireless communications, and more specifically to network energy savings and wireless coverage optimization.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

The wireless communications system may support wireless communications, and may include one or more devices, such as UEs, base stations (e.g., gNBs), network entities, satellites, and/or network equipment (NE), among other devices, that transmit and/or receive signaling.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may include a UE for wireless communication to receive signaling including configuration for common Discrete Fourier Transform (DFT) spreading length of a DFT-spread-Orthogonal Frequency Division Multiplexing (DFT-s-OFDM) waveform, the common DFT spreading length configured for a common sub-band generated using contiguous frequency domain resource blocks for a group of UEs; and receive at least one of common channel (e.g., common physical channel), control channel (e.g., control physical channel), or data channel (e.g., data physical channel) within the common sub-band using the common DFT spreading length of the DFT-s-OFDM waveform.

In some implementations of the method and apparatuses for a UE described herein, the configuration includes information of the common spreading length and location of frequency resources of the common sub-band; the configuration includes time domain information for time resources for each UE of the group of UEs mapped prior to applying DFT, and wherein the time domain information is indicated by a bit map of time resources or via interleaving information indicating a location of the time domain resources; the at least one processor is configured to cause the UE to receive the configuration including time-frequency resource for transmission to each UE of the group of UEs within the common sub-band via one or more of dedicated downlink control information (DCI), via group DCI, or via radio resource control (RRC), or a combination thereof; the configuration includes information of one or more of a group common demodulation reference signal (DMRS) type, a DMRS waveform, or DMRS location within the common sub-band; the at least one processor is configured to cause the UE to receive the configuration via one or more of a row index of a table sent via dedicated DCI, via group DCI, or via RRC; the configuration includes information of the length and location of frequency resources of the common sub-band.

Some implementations of the method and apparatuses described herein may further include a processor for wireless communication to receive signaling including configuration for common DFT spreading length of a DFT-s-OFDM waveform, the common DFT spreading length configured for a common sub-band generated using contiguous frequency domain resource blocks for a group of UEs; and receive at least one of common channel, control channel, or data channel within the common sub-band using the common DFT spreading length of the DFT-s-OFDM waveform. The common spreading length applied on the common sub-band transmitting DFT-s-OFDM can be semi-statically configured and signaled to the UE as part of the common sub-band configuration.

Some implementations of the method and apparatuses described herein may further include a method performed by a UE, the method including receiving signaling including configuration for common DFT spreading length of a DFT-s-OFDM waveform, the common DFT spreading length configured for a common sub-band generated using contiguous frequency domain resource blocks for a group of UEs; and receiving at least one of common channel, control channel, or data channel within the common sub-band using the common DFT spreading length of the DFT-s-OFDM waveform.

In some implementations of the method and apparatuses for a UE described herein, the configuration includes information of the spreading length and location of frequency resources of the common sub-band; the configuration includes time domain information for time resources for each UE of the group of UEs mapped prior to applying DFT, and wherein the time domain information is indicated by a bit map of time resources or via interleaving information indicating a location of the time domain resources; receiving the configuration including time-frequency resource for transmission to each UE of the group of UEs within the common sub-band via one or more of dedicated DCI, via group DCI, or via RRC, or a combination thereof; the configuration includes information of one or more of a group common DMRS type, a DMRS waveform, or DMRS location within the common sub-band; receiving the configuration via one or more of a row index of a table sent via dedicated DCI, via group DCI, or via RRC; the configuration includes information of the length and location of frequency resources of the common sub-band.

Some implementations of the method and apparatuses described herein may further include a NE for wireless communication to transmit signaling comprising a configuration for a common DFT spreading length of a DFT-s-OFDM waveform, the common DFT spreading length configured for a common sub-band generated using contiguous frequency domain resource blocks for a group of user equipment (UEs); and transmit a DFT-s-OFDM waveform over at least one of common channel, control channel, or data channel within the common sub-band and according to the common DFT spreading length of the DFT-s-OFDM waveform.

In some implementations of the method and apparatuses for a NE described herein, the at least one processor is configured to cause the network equipment to determine the common DFT spreading length of the DFT-s-OFDM waveform based on one or more of a peak to average power ratio (PAPR) gain for the common sub-band used in a connected mode for the group of UEs, or a synchronization signal block (SSB) or control resource set (CORESET) #0 bandwidth for an initial sub-band used for initial access; the at least one processor is configured to cause the network equipment to determine a number of sub-bands within a bandwidth part (BWP) or a carrier and based at least in part on the BWP or a carrier total bandwidth and the PAPR gain; the at least one processor is configured to cause the network equipment to determine CORESET a grouping configuration of UEs to be served with the common sub-band and the common DFT spreading length of the DFT-s-OFDM waveform based at least in part on serving beams or SSB beams of the group of UEs; the at least one processor is configured to cause the network equipment to determine the configuration and the group of UEs to be served with the common sub-band and the common DFT spreading length of the DFT-s-OFDM waveform based at least in part on beam coverage of the network equipment or a proximity of each UE to the network equipment; the configuration is semi-static and identifies the common sub-band containing common spreading length and location of frequency resources of the common sub-band.

In some implementations of the method and apparatuses for a NE described herein, the configuration includes time domain information for time resources for each UE of the group of UEs mapped prior to applying DFT, and wherein the time domain information is indicated by a bit map of time resources or via interleaving information indicating a location of the time domain resources; the at least one processor is configured to cause the network equipment to signal the configuration including time-frequency resource for transmission to each UE of the group of UEs within the common sub-band via one or more of dedicated DCI, via group DCI, or via RRC, or a combination thereof; the configuration includes information of one or more of a group common DMRS type, a DMRS waveform, or DMRS location within the common sub-band; the at least one processor is configured to cause the network equipment to signal the configuration via one or more of a row index of a table sent via dedicated DCI to each UE of the group of UEs, via group DCI, or via RRC; the configuration includes information of the length and location of frequency resources of the common sub-band.

Some implementations of the method and apparatuses described herein may further include a method performed by a NE, the method including transmitting signaling comprising a configuration for a common DFT spreading length of a DFT-s-OFDM waveform, the common DFT spreading length configured for a common sub-band generated using contiguous frequency domain resource blocks for a group of UEs; and transmitting a DFT-s-OFDM waveform over at least one of common channel, control channel, or data channel within the common sub-band and according to the common DFT spreading length of the DFT-s-OFDM waveform.

In some implementations of the method and apparatuses for a NE described herein, the method further comprising determining the common DFT spreading length of the DFT-s-OFDM waveform based on one or more of an PAPR gain for the common sub-band used in a connected mode for the group of UEs, or a SSB or CORESET #0 bandwidth for an initial sub-band used for initial access; determining a number of sub-bands within a BWP or a carrier and based at least in part on the BWP or a carrier total bandwidth and the PAPR gain; further including determining a grouping respective configuration applicable for the group of UEs to be served within the common sub-band and the common DFT spreading length of the DFT-s-OFDM waveform based at least in part on serving beams or SSB beams of the group of UEs; determining the configuration and the group of UEs to be served with the common sub-band and the common DFT spreading length of the DFT-s-OFDM waveform based at least in part on beam coverage of the network equipment or a proximity of each UE to the network equipment; the configuration is semi-static and identifies the common sub-band containing common spreading length and location of frequency resources of the common sub-band.

In some implementations of the method and apparatuses for a NE described herein, the method further comprising where the configuration includes time domain information for time resources for each UE of the group of UEs mapped prior to applying DFT, and wherein the time domain information is indicated by a bit map of time resources or via interleaving information indicating a location of the time domain resources; signaling the configuration including time-frequency resource for transmission to each UE of the group of UEs within the common sub-band via one or more of dedicated DCI, via group DCI, or via RRC, or a combination thereof; the configuration includes information of one or more of a group common DMRS type, a DMRS waveform, or DMRS location within the common sub-band; further including signaling the configuration via one or more of a row index of a table sent via dedicated DCI to each UE of the group of UEs, via group DCI, or via RRC; the configuration includes information of the length and location of frequency resources of the common sub-band.

### BRIEF DESCRIPTION OF THE DRAWINGS

FIG. 1 illustrates an example of a wireless communications system in accordance with aspects of the present disclosure.

FIG. 2 illustrates an example scenario for sub-band group DFTs for multiple UEs in accordance with aspects of the present disclosure.

FIG. 3 illustrates a scenario for grouping based on serving beam and/or SSB beam in accordance with aspects of the present disclosure.

FIG. 4 illustrates an example scenario for UE grouping based on UE coverage and/or proximity in in accordance with aspects of the present disclosure.

FIGS. 5 and 6 illustrate example scenarios in accordance with aspects of the present disclosure.

FIG. 7 illustrates an example of a UE in accordance with aspects of the present disclosure.

FIG. 8 illustrates an example of a processor in accordance with aspects of the present disclosure.

FIG. 9 illustrates an example of a NE in accordance with aspects of the present disclosure.

FIG. 10 illustrates a flowchart of a method in accordance with aspects of the present disclosure.

FIG. 11 illustrates a flowchart of a method in accordance with aspects of the present disclosure.

### DETAILED DESCRIPTION

In a wireless communications system, a UE and a NE (e.g., a base station, gNB) may support wireless communication (e.g., reception and/or transmission of wireless communication) using time-frequency resources. The wireless communications system, including one or more of the UE or the NE may support multiplexing to support efficient wireless communication. Examples of multiplexing may include, frequency division multiplexing (FDM), time division multiplexing (TDM), OFDM, etc. For example, one or more of the UE or the NE may support efficient usage of time-frequency resources by supporting OFDM. According to OFDM, one or more of the UE or the NE may combine an array of subcarriers to transmit a signal over a set of one or more (e.g., range) of frequencies. The subcarriers may be secondary signal frequencies modulated onto a main frequency (e.g., a carrier) to provide additional channels of transmission. Additionally, each subcarrier can carry a portion of data and can be modulated with a modulation scheme (e.g., quadrature amplitude modulation (QAM) or phase-shift keying (PSK)) to generate OFDM symbols each associated with respective sets of one or more subcarriers.

To mitigate the inter-symbol interference resulting from the multipath channel propagation, one or more of the UE or the NE may prepend (e.g., apply) a cyclic prefix (CP) to each OFDM symbol, also referred to a CP-OFDM. In some wireless communications systems, such as in 5G NR system, the CP-OFDM-based waveform has been adopted for downlink (DL) and uplink (UL). However, utilizing CP-OFDM can introduce degradation in power amplifier (PA) efficiency due to high PAPR and the need for backoff at a transmitter, which can also limit achievable coverage. Since network energy saving (NES) and DL coverage extension are increasing important in wireless communication systems, adopting low PAPR waveforms such as DFT-s-OFDM for DL can realize advantages towards achieving NES and better wireless coverage. DFT-s-OFDM, for instance, is a single carrier transmission scheme where each receiver and/or transmitter can be allocated a single carrier and a portion of available channel bandwidth. Further, DFT-s-OFDM can utilize wireless spectrum efficiently by combining multiple users (e.g., UEs) orthogonally.

However, when using DFT-s-OFDM in DL, as the number of scheduled UEs in DL increases, the benefit of using DFT-s-OFDM can decrease. For instance, gains in PAPR reduction when using DFT-s-OFDM can be based at least in part on the length of DFT, e.g., the allocated resources for each UE in the carrier bandwidth. For example, the longer the DFT spreading, the lower the PAPR that can be achieved. Using a single DFT for each UE, however, may not be required for DL compared to UL since NE can transmit the DL signal for multiple UEs at the same time (e.g., FDMed in case of CP-OFDM) which motivates using a longer DFT spreading over multiple UE resources to achieve lower PAPR.

Aspects of the present disclosure are described in the context of a wireless communications system, and include implementations that provide for applying a single DFT spreading for plurality of UEs allocated in DL to enhance DL coverage. For instance, instead of applying different DFTs for different UEs (e.g., based on UEs allocations/resource blocks (RBs) as done for UL DFT-s-OFDM), this disclosure describes a single DFT applied to a sub-band created using a contiguous group of RBs in the frequency domain. Further, a group of UEs can be allocated within the sub-band to enhance the coverage and the UEs can be signaled with configuration regarding the DFT spreading length to be applied at the receiver. Implementations include DFT spreading that can be applied on the sub-band containing data channels, control channels, and/or common channels of multiple UEs. The sub-band bandwidth may be associated with BWP bandwidth or can be configured within a BWP bandwidth, where in such cases the BWP may contain a plurality of sub-bands.

By performing the described techniques, a device in a wireless communications system can reduce power usage and increase wireless coverage.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

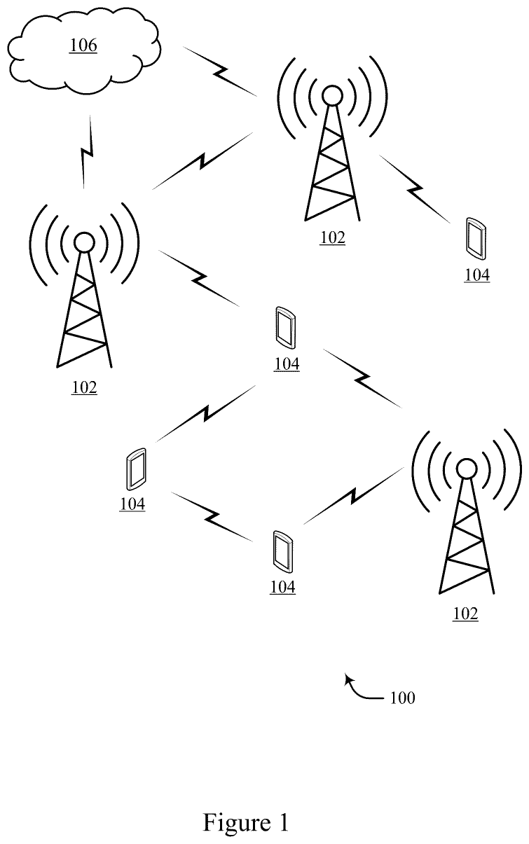

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHZ), FR3 (7.125 GHZ-24.25 GHZ), FR4 (52.6 GHz-114.25 GHZ), FR4a or FR4-1 (52.6 GHZ-71 GHZ), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, a UE 104 receives (e.g., obtains, retrieves) from a NE 102, signaling including configuration for common DFT spreading length of a DFT-s-OFDM waveform. The common DFT spreading length, for instance, is configured for a common sub-band generated using contiguous frequency domain resource blocks for a group of UEs. The UE 104 receives, from the NE 102, at least one of common channel, control channel, or data channel within the common sub-band using the common DFT spreading length of the DFT-s-OFDM waveform.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

With reference to UE procedures for receiving physical downlink shared channel (PDSCH) and resource allocation in the frequency domain, downlink resource allocation schemes, type 0 and type 1, can be supported. A UE can assume that when the scheduling grant is received with DCI format 1_0, 4_0 or 4_1 then downlink resource allocation type 1 can be used. If the scheduling DCI is configured to indicate the downlink resource allocation type as part of the ‘Frequency domain resource assignment’ field by setting a higher layer parameter resourceAllocation in PDSCH-Config to ‘dynamicSwitch’, for DCI format 1_1 or setting a higher layer parameter resourceAllocationDCI-1-2 in PDSCH-Config to ‘dynamicSwitch’ for DCI format 1_2 or setting a higher layer parameter resourceAllocationDCI-1-3 in PDSCH-ConfigDCI-1-3 to ‘dynamicSwitch’ for DCI format 1_3 or setting a higher layer parameter resourceAllocation in pdsch-ConfigMulticast to ‘dynamicSwitch’ for DCI format 4_2, the UE can use downlink resource allocation type 0 or type 1 as defined by this DCI field. Otherwise the UE can use the downlink frequency resource allocation type as defined by the higher layer parameter resourceAllocation in PDSCH-Config for DCI format 1_1 or by the higher layer parameter resourceAllocationDCI-1-2 for DCI format 1_2 or by the higher layer parameter resourceAllocationDCI-1-3 for DCI format 1_3 or by the higher layer parameter resourceAllocation in pdsch-ConfigMulticast for DCI format 4_2.

If a bandwidth part indicator field is not configured in the scheduling DCI or the UE does not support active BWP change via DCI, the RB indexing for downlink type 0 and type 1 resource allocation can be determined within the UE's active bandwidth part. If a bandwidth part indicator field is configured in the scheduling DCI and the UE supports active BWP change via DCI, the RB indexing for downlink type 0 and type 1 resource allocation can be determined within the UE's bandwidth part indicated by bandwidth part indicator field value in the DCI. The UE can upon detection of physical downlink control channel (PDCCH) intended for the UE determine first the downlink bandwidth part and then the resource allocation within the bandwidth part.

For a PDSCH scheduled with a DCI format 1_0 in any type of PDCCH common search space, regardless of which bandwidth part is the active bandwidth part, RB numbering can start from the lowest RB of the CORESET in which the DCI was received; otherwise RB numbering can start from the lowest RB in the determined downlink bandwidth part. When the PDCCH reception includes two PDCCH candidates from two respective search space sets, as described in clause 10.1 of [3GPP technical specification (TS) 38.213], for the purpose of determining the downlink RB set of a PDSCH when scheduled by DCI format 1_0, the CORESET with lower ID among two CORESETs associated with two PDCCH candidates is used.

For downlink resource allocation type 0, in downlink resource allocation of type 0, the resource block assignment information includes a bitmap indicating the Resource Block Groups (RBGs) that are allocated to the scheduled UE where a RBG is a set of consecutive virtual resource blocks defined by higher layer parameter rbg-Size configured by PDSCH-Config for DCI format 1_1 or 1_2 or by higher layer parameter rbg-SizeDCI-1-3 configured by PDSCH-ConfigDCI-1-3 for DCI format 1_3 and the size of the bandwidth part as defined in Table 5.1.2.2.1-1 from TS 38.214 v18, below.

TABLE 5.1.2.2.1-1
Nominal RBG size P

| Bandwidth | | | |
|---|---|---|---|
| Part Size | Configuration 1 | Configuration 2 | Configuration 3 |
| 1-36 | 2 | 4 | 8 |
| 37-72 | 4 | 8 | 16 |
| 73-144 | 8 | 16 | 32 |
| 145-275 | 16 | 16 | 32 |

The total number of RBGs (N_{RBG}) for a downlink bandwidth part i of size

$${N}_{BWP , i}^{size}$$

physical resource blocks (PRBs) is given by

$${N}_{RBG} = ⌈ ( {N}_{BWP , i}^{size} + ( {N}_{BWP , i}^{start} mod P ) ) / P ⌉ ,$$

where
the size of the first RBG is

$${RBG}_{0}^{size} = P - {N}_{BWP , i}^{start} mod P ,$$

the size of last RBG is

$${RBG}_{last}^{size} = ( {N}_{BWP , i}^{start} + {N}_{BWP , i}^{size} ) mod P if ( {N}_{BWP , i}^{start} + {N}_{BWP , i}^{size} ) mod P > 0$$

and P otherwise,
the size of all other RBGs is P.

In downlink resource allocation of type 0 scheduled using a DCI with cyclic redundancy check (CRC) scrambled by G-RNTI for multicast or G-configured scheduling (CS)-radio network temporary identifier (RNTI), the resource block assignment information bitmap is calculated based on the description above with the following changes: the parameter

$${N}_{BWP , i}^{start}$$

is the starting PRB of the common frequency resource (CFR),

$${N}_{BWP , i}^{size}$$

is the size of the CFR and the value of the higher layer parameter rbg-Size is configured by pdsch-ConfigMulticast. The bitmap is of size N_{RBG} bits with one bitmap bit per RBG such that each RBG is addressable. The RBGs can be indexed in the order of increasing frequency and starting at the lowest frequency of the bandwidth part. The order of RBG bitmap is such that RBG 0 to RBG_{N}_{_{RBG}}₋₁ are mapped from most significant bit (MSB) to least significant bit (LSB). The RBG is allocated to the UE if the corresponding bit value in the bitmap is 1, the RBG is not allocated to the UE otherwise.

For downlink resource allocation type 1, the resource block assignment information indicates to a scheduled UE a set of contiguously allocated non-interleaved or interleaved virtual resource blocks within the active bandwidth part of size

$${N}_{BWP}^{size}$$

PRBs except for the case when DCI format 1_0 is decoded in any common search space in which case the size of CORESET 0 can be used if CORESET 0 is configured for the cell and the size of initial DL bandwidth part can be used if CORESET 0 is not configured for the cell.

A downlink type 1 resource allocation field consists of a resource indication value (RIV) corresponding to a starting virtual resource block (RBₛₜₐᵣₜ) and a length in terms of contiguously allocated resource blocks L_{RBs}. The resource indication value is defined by

$$if ( {L}_{RBs} - 1 ) \leq ⌊ {N}_{BWP}^{size} / 2 ⌋ then$$

$$RIV = {N}_{BWP}^{size} ( {L}_{RBs} - 1 ) + {RB}_{start}$$

$$else$$

$$RIV = {N}_{BWP}^{size} ( {N}_{BWP}^{size} - {L}_{RBs} + 1 ) + ( {N}_{BWP}^{size} - 1 - {RB}_{start} )$$

where L_{RBs}≥1 and cannot exceed

$${N}_{BWP}^{size} - R {B}_{start} .$$

The PRB bundling procedures for PDSCH scheduled by PDCCH with DCI format 1_1 can apply to PDSCH scheduled by PDCCH with DCI format 1_2, by applying the parameters of prb-BundlingTypeDCI-1-2 instead of prb-BundlingType as well as vrb-ToPRB-InterleaverDCI-1-2 instead of vrb-ToPRB-Interleaver. The PRB bundling procedures for PDSCH scheduled by PDCCH with DCI format 1_1 can apply to PDSCH scheduled by PDCCH with DCI format 1_3. The PRB bundling procedures for PDSCH scheduled by PDCCH with DCI format 1_1 can apply to PDSCH scheduled by PDCCH with DCI format 4_2, by applying the parameters of prb-BundlingType given by pdsch-ConfigMulticast as well as vrb-ToPRB-Interleaver given by pdsch-ConfigMulticast.

A UE may assume that precoding granularity is

$${P}_{BWP , i}^{′}$$

consecutive resource blocks in the frequency domain.

$${P}_{BWP , i}^{′}$$

can be equal to one of the values among {2, 4, wideband}. If

$${P}_{BWP , i}^{′}$$

is determined as “wideband”, the UE is not expected to be scheduled with non-contiguous PRBs and the UE may assume that the same precoding is applied to the allocated resource associated with a same transmission configuration indicator (TCI) state or a same quasi co-location (QCL) assumption. If

$${P}_{BWP , i}^{′}$$

is determined as one of the values among {2, 4}, Precoding Resource Block Group (PRGs) partitions the bandwidth part i with

$${P}_{BWP , i}^{′}$$

consecutive PRBs. Actual number of consecutive PRBs in each PRG could be one or more.

The first PRG size is given by

$${P}_{BWP , i}^{′} - {N}_{BWP , i}^{start} {modP}_{BWP , i}^{′}$$

and the last PRG size given by

$$( {N}_{BWP , i}^{start} + {N}_{BWP , i}^{size} ) {modP}_{BWP , i}^{′}$$

if

$$( {N}_{BWP , i}^{start} + {N}_{BWP , i}^{size} ) {modP}_{BWP , i}^{′} \neq 0 ,$$

and the last PRG size is

$${P}_{BWP , i}^{′}$$

if

$$( {N}_{BWP , i}^{start} + {N}_{BWP , i}^{size} ) {modP}_{BWP , i}^{′} = 0.$$

For PDSCH scheduled by PDCCH with DCI scrambled using G-RNTI or G-CS-RNTI,

$${N}_{BWP , i}^{start}$$

is the starting PRB of the CFR and

$${N}_{BWP , i}^{size}$$

is the CFR. The UE may assume the same precoding is applied for any downlink contiguous allocation of PRBs in a PRG. For PDSCH carrying SIB1 scheduled by PDCCH with CRC scrambled by SI-RNTI, a PRG is partitioned from the lowest numbered resource block of CORESET 0 if the corresponding PDCCH is associated with CORESET 0 and Type0-PDCCH common search space and is addressed to SI-RNTI; otherwise, a PRG is partitioned from common resource block 0.

If a UE is scheduled a PDSCH with DCI format 1_0 or 4_0 for broadcast or 4_1 for multicast, the UE can assume that

$${P}_{BWP , i}^{′}$$

is equal to 2 PRBS. When receiving PDSCH scheduled by PDCCH with DCI format 1_1 with CRC scrambled by C-RNTI, MCS-C-RNTI, CS-RNTI,

$${P}_{BWP , i}^{′}$$

for bandwidth part is equal to 2 PRBs unless configured by the higher layer parameter prb-BundlingType given by PDSCH-Config. When receiving PDSCH scheduled by PDCCH with DCI format 1_1 with CRC scrambled by C-RNTI, MCS-C-RNTI, or CS-RNTI, if the higher layer parameter prb-BundlingType is set to ‘dynamicBundling’, the higher layer parameters bundleSizeSet1 and bundleSizeSet2 configure two sets of

$${P}_{BPW , i}^{′}$$

values, the first set can take one or two

$${P}_{BPW , i}^{′}$$

values among {2, 4, wideband}, and the second set can take one

$${P}_{BPW , i}^{′}$$

value among {2, 4, wideband}.

If the PRB ‘bundling size indicator’ signalled in DCI format 1_1 as defined in Clause 7.3.1.2.2 of [TS 38.212]
is set to ‘0’, the UE can use the

$${P}_{BPW , i}^{′}$$

value from the second set of

$${P}_{BPW , i}^{′}$$

values when receiving PDSCH scheduled by the same DCI.
is set to ‘1’ and one value is configured for the first set of

$${P}_{BPW , i}^{′}$$

values, the UE can use this

$${P}_{BPW , i}^{′}$$

value when receiving PDSCH scheduled by the same DCI
is set to ‘1’ and two values are configured for the first set of

$${P}_{BPW , i}^{′}$$

values as ‘n2-wideband’ (corresponding to two

$${P}_{BPW , i}^{′}$$

values 2 and the wideband) or ‘n4-wideband’ (corresponding to two

$${P}_{BPW , i}^{′}$$

values 4 and wideband), the UE can use the value when receiving PDSCH scheduled by the same DCI as follows: If the scheduled PRBs are contiguous and the size of the scheduled PRBs is larger than

$${N}_{BWP , i}^{s i z e} / 2 ,$$

$${P}_{BPW , i}^{′}$$

is the same as the scheduled bandwidth, otherwise

$${P}_{BPW , i}^{′}$$

is set to the remaining configured value of 2 or 4, respectively.

Regarding UE procedures for receiving control information, if a UE is configured with a secondary cell group (SCG), the UE can apply the procedures described in this clause for both master cell group (MCG) and SCG except for PDCCH monitoring in Type0/0A/0B/2/2A-PDCCH common search space (CSS) sets where the UE is not required to apply procedures for the SCG. When the procedures are applied for MCG, the terms ‘secondary cell’, ‘secondary cells’, ‘serving cell’, ‘serving cells’ in this clause refer to secondary cell, secondary cells, serving cell, serving cells belonging to the MCG respectively. When the procedures are applied for SCG, the terms ‘secondary cell’, ‘secondary cells’, ‘serving cell’, ‘serving cells’ in this clause refer to secondary cell, secondary cells (not including PSCell), serving cell, serving cells belonging to the SCG respectively. The term ‘primary cell’ in this clause refers to the PSCell of the SCG.

A UE can monitor a set of PDCCH candidates in one or more CORESETs on the active DL BWP on each activated serving cell configured with PDCCH monitoring according to corresponding search space sets where monitoring implies receiving each PDCCH candidate and decoding according to the monitored DCI formats. In at least some scenarios, when a PDCCH reception by a UE includes two PDCCH candidates from corresponding search space sets: a PDCCH monitoring occasion is the union of the PDCCH monitoring occasions for the two PDCCH candidates; the start of the PDCCH reception is the start of the earlier PDCCH candidate; the end of the PDCCH reception is the end of the PDCCH candidate that ends later.

The PDCCH reception includes the two PDCCH candidates also when the UE is not required to monitor one of the two PDCCH candidates as described in clauses 10 (except clause 10.4), 11.1, 11.1.1 and 17.2 [TS 38.212]. If a UE is provided monitoring CapabilityConfig for a serving cell, the UE obtains an indication to monitor PDCCH on the active DL BWP of the serving cell for a maximum number of PDCCH candidates and non-overlapping CCEs
per slot, as in Tables 10.1-2 and 10.1-3, if monitoringCapabilityConfig=r15monitoringcapability, or
per span, as in Tables 10.1-2A and 10.1-3A, if monitoringCapabilityConfig=r16monitoringcapability, or
per group of Xₛ slots according to combination (Xₛ, Yₛ), as in Tables 10.1-2B and 10.1-3B, if monitoringCapabilityConfig=r17monitoringcapability

The remainder of this clause, including clause 10.1, considers that a UE is provided monitoringCapabilityConfig for a serving cell. If the UE is not provided monitoringCapabilityConfig for the serving cell, corresponding statements that the UE is provided monitoringCapabilityConfig for the serving cell are substituted as follows
for subcarrier spacing (SCS) configuration μ∈{0, 1, 2, 3}, the UE monitors PDCCH on the active DL BWP of the serving cell for maximum numbers of PDCCH candidates and non-overlapping CCEs per slot as in Tables 10.1-2 and 10.1-3.
for SCS configuration μ∈{5, 6}, the UE monitors PDCCH on the active DL BWP of the serving cell for maximum numbers of PDCCH candidates and non-overlapping CCEs per group of Xₛ slots according to combination (Xₛ, Yₛ)=(4, 1) for μ=5 and (Xₛ, Yₛ)=(8, 1) for μ=6 as in Tables 10.1-2B and 10.1-3B.

The UE does not expect to monitor PDCCH with SCS configuration μ=6 before the UE is provided dedicated higher layer parameters. A UE can indicate a capability to monitor PDCCH according to one or more of the combinations (X, Y)=(2, 2), (4, 3), and (7, 3) per SCS configuration of μ=0 and μ=1. A span is a number of consecutive symbols in a slot where the UE is configured to monitor PDCCH. Each PDCCH monitoring occasion is within one span. If a UE monitors PDCCH on a cell according to combination (X, Y), the UE supports PDCCH monitoring occasions in any symbol of a slot with minimum time separation of X symbols between the first symbol of two consecutive spans, including across slots. A span starts at a first symbol where a PDCCH monitoring occasion starts and ends at a last symbol where a PDCCH monitoring occasion ends, where the number of symbols of the span is up to Y.

If a UE indicates a capability to monitor PDCCH according to multiple (X, Y) combinations and a configuration of search space sets to the UE for PDCCH monitoring on a cell results to a separation of every two consecutive PDCCH monitoring spans that is equal to or larger than the value of X for more than one of the multiple combinations (X, Y), the UE monitors PDCCH on the cell according to the combination (X, Y), from the more than one combinations (X, Y), that is associated with the largest maximum number of

$${M}_{PDCCH}^{max , ( X , Y ) , μ} and {C}_{PDCCH}^{max , ( X , Y ) , μ}$$

defined in Table 10.1-2A and Table 10.1-3A. The UE expects to monitor PDCCH according to the same combination (X, Y) in every slot on the active DL BWP of a cell.

For SCS configuration μ=5 or μ=6, a UE can indicate a capability to monitor PDCCH according to one or more combinations (Xₛ, Yₛ), where Xₛ and Yₛ are numbers of consecutive slots. Groups of Xₛ slots are consecutive and non-overlapping and the Yₛ slots are within the Xₛ slots. The first group of Xₛ slots starts from the beginning of a subframe. The start of two consecutive groups of Yₛ slots is separated by Xₛ slots. If a UE monitors PDCCH on a cell according to combination (Xₛ, Yₛ), the UE can monitor PDCCH for Type1-PDCCH CSS set provided by dedicated higher layer signalling, Type3-PDCCH CSS sets, and user-specific search space (USS) sets in any slot of the Yₛ slots, and the UE can monitor PDCCH for Type0/0A/2-PDCCH CSS set and Type1-PDCCH CSS set provided in SIB1 in any slot of the Xₛ slots. The UE determines the number of monitored PDCCH candidates and the number of non-overlapped CCEs for combination (Xₛ, Yₛ) based on all search space sets within the Xₛ slots, as applicable according to the search space set configurations, and maximum corresponding values are provided in Table 10.1-2B and Table 10.1-3B, respectively.

For μ=6, if the UE indicates a capability to monitor PDCCH according to multiple combinations (Xₛ, Yₛ) and a configuration of search space sets to the UE for PDCCH monitoring on a serving cell results to a separation of every two consecutive groups of Yₛ slots that is not smaller than Xₛ for more than one combinations (Xₛ, Yₛ), of the multiple combinations (Xₛ, Yₛ), the UE monitors PDCCH on the cell according to the combination (Xₛ, Yₛ), from the more than one combinations (Xₛ, Yₛ), that is associated with the largest maximum number of

$${M}_{PDCCH}^{max , {X}_{s} , μ} and {C}_{PDCCH}^{max , {X}_{s} , μ}$$

defined in Table 10.1-2B and Table 10.1-3B. A UE capability for PDCCH monitoring per slot, or per group of Xₛ slots according to combination (Xₛ, Yₛ), or per span on an active DL BWP of a serving cell is defined by a maximum number of PDCCH candidates and non-overlapped CCEs the UE can monitor per slot, or per group of Xₛ slots according to combination (Xₛ, Yₛ), or per span, respectively, on the active DL BWP of the serving cell.

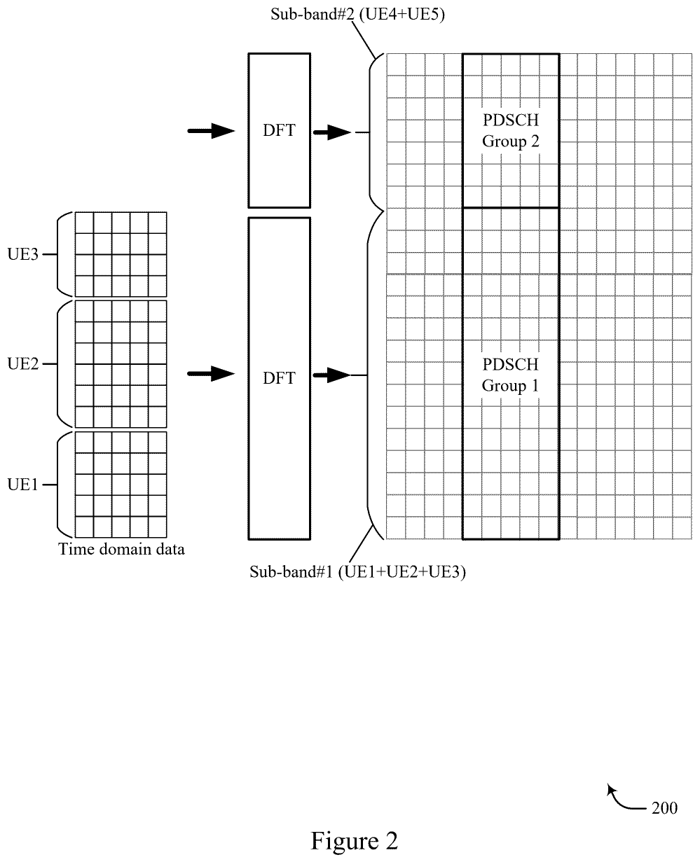

FIG. 2 illustrates an example scenario 200 for sub-band group DFTs for multiple UEs in accordance with aspects of the present disclosure. The scenario 200 includes a UE1, UE2, and UE3 sharing a single DFT in a sub-band #1 for PDSCH. For instance, in scenarios for using DFT-s-OFDM in DL, as the number of scheduled UEs in a certain carrier bandwidth increases, the benefit of DFT-s-OFDM can decrease since the gain of PAPR reduction can depend on the length of DFT. The longer the DFT spreading, the lower the PAPR that can be achieved. Instead of applying different DFTs for different UEs (e.g., based on UEs allocations/RBs as done for UL DFT-s-OFDM), this disclosure describes a single DFT applied to a sub-band created using a contiguous group of RBs in the frequency domain. Further, a group of UEs is allocated within the sub-band to enhance the coverage and the UEs are signaled with configuration regarding the DFT spreading length to be applied at the receiver. DFT spreading can be applied on the sub-band containing data channels, control channels, and/or common channels of multiple UEs, where the sub-band bandwidth may be related to BWP bandwidth or can be configured within a BWP bandwidth where in such cases the BWP may contain a plurality of sub-bands.

The DL physical channels transmitted within the sub-band can be configured for unicast, groupcast common, control channel, and data channel transmissions. Sub-bands can be defined and configured by NE based on UE(s) beam, location, and/or coverage. Different sub-bands containing contiguous RBs created using DFT-spreading can be configured for different groups of UEs, e.g., group specific sub-band configuration. UEs within close proximity/good coverage can be served with CP-OFDM, e.g., scheduled in sub-band #1. UEs with medium coverage can be scheduled in sub-band #2 with short DFT length based DFT-s-OFDM or can be scheduled individually with DFT spreading (DFT-s-OFDM) without grouping. Cell-edge UEs in bad coverage scenario with low signal to interference plus noise ratio (SINR) can be configured within sub-band #3 configured using long DFT spreading (DFT-s-OFDM). Since, each sub-band or BWP can be configured with different DFT spreading length for DFT-s-OFDM, UE may be signalled with the waveform type (e.g., CP-OFDM or DFT-s-OFDM) then DFT spreading length can be applied to the sub-band when DFT-s-OFDM is configured in that sub-band, etc.

In implementations, a single DFT is performed on the time domain data of plurality of UEs in DL to generate sub-band combined contiguous frequency domain resources from the plurality of UEs. For instance, a single DFT based DFT-s-OFDM waveform can be applied to a sub-band created using a contiguous group of RBs in the frequency domain where a group of UEs can be allocated within the sub-band. Physical channels transmitted within the sub-band can be configured for unicast, groupcast common, control channel, and data channel transmissions. The resources can be mapped to the corresponding frequency resource elements prior to inverse Fast Fourier Transform (IFFT), which can result in a reduced PAPR compared to the separate DFTs performed on the data of each scheduled UE.

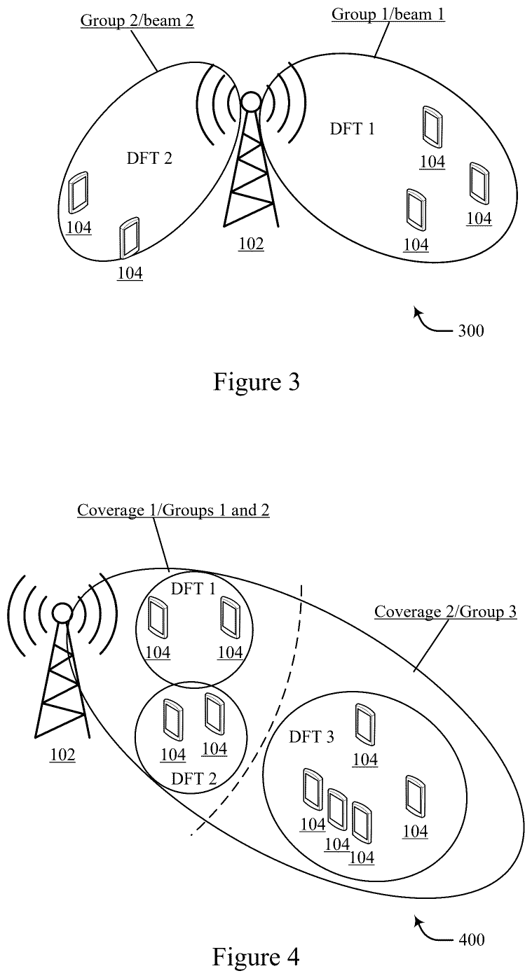

FIG. 3 illustrates a scenario 300 for grouping based on serving beam and/or SSB beam in accordance with aspects of the present disclosure. The plurality of UEs sharing same DFT spreading length scheduled in the same sub-band can be grouped based on the serving beam or SSB beams as shown in the scenario 300. For example, UEs located in the same direction of a beam can be served by a sub-band containing single beam and single DFT spreading length. This grouping is useful to allow sending group common DMRS (beamformed based on serving beam) configured per sub-band that cover the frequency band shared between the UEs in the group.

In implementations, time domain resources (constellation points) for each UE can be concatenated to form the total length of DFT, and DFT can be applied on the concatenated time domain constellation symbols after serial to parallel conversion. In another implementation, time domain resources of UEs can be interleaved prior to DFT spreading. A time domain allocation bit map for each UE within the sub-band can be sent to the UE via codepoint transmitted in a dedicated DCI. The length and location of shared frequency domain resources can be sent via codepoint in a dedicated DCI to each UE occupied within the sub-band or via a codepoint transmitted using a group common DCI dedicated to the group of UEs occupying the sub-band.

In implementations, prior to assigning a DFT/sub-band for a group of UEs, UEs may be initially served with a different waveform (e.g., CP-OFDM or DFT-s-OFDM waveform) assigned to different DFT spread sub-band dedicated for initial access or indicated as an initial sub-band for accessing the network for initial access. The DFT spreading length can be implicitly conveyed to UEs by configuring the DFT spreading length equal to the SSB bandwidth and/or COREST #0 bandwidth which can be used to convey the scheduling information for PDSCH carrying required minimum system information (RMSI). In one implementation, NE can group the UEs based on their initial serving beam(s) before assignment, e.g., if the UEs use similar beam/TCI state.

In another implementation, NE groups the UEs based on their measurement reports. For example, UEs that report similar channel state information (CSI) (indicating same CSI-RS measured with highest reference signal received power (RSRP)) can be grouped together and served with same beam and single DFT spreading assigned to a sub-band. UE may be signaled with the DFT spreading length using one or more signaling options including: 1) signaled using a codepoint configured in a dedicated or group common DCI; 2) As part of the semi-static sub-band configuration or BWP configuration provided using RRC signaling; 3) The maximum number of sub-band configured within a BWP or carrier can be semi-statically signaled to the UE as a function of bandwidth of BWP or carrier and can be fixed in specification.

FIG. 4 illustrates an example scenario 400 for UE grouping based on UE coverage and/or proximity in in accordance with aspects of the present disclosure. In implementations, a single DFT can be performed on the time domain data of plurality of UEs in DL to generate combined frequency domain resources for the plurality of UEs. For instance, a single DFT based DFT-s-OFDM waveform can be applied to a sub-band created using a contiguous group of RBs in the frequency domain where a group of UEs is allocated within the sub-band. The physical channels transmitted within the sub-band can be configured for unicast, groupcast, control channel, and data channel transmissions. These resources can be mapped to the corresponding frequency resource elements prior to IFFT, which can enable reduced PAPR compared to the separate DFTs performed on the data of each scheduled UE.

In implementations the plurality of UEs sharing same DFT can be grouped based on their location/range from NE. For example, UEs located near to NE can be served by a single beam and single DFT spreading, such as illustrated in the scenario 400. UEs located farther from NE can be served by different DFT spreading. Each group can be FDMed in frequency using OFDMA. In one implementation, time domain resources (constellation points) for all UEs in a group can be concatenated to form the total length of DFT, and the DFT can be applied on the concatenated time domain constellation symbols after serial to parallel conversion. In another implementation, time domain resources of UEs are interleaved prior to DFT spreading. A time domain allocation bit map can be sent to the UE via dedicated DCI. Group common DMRS (dedicated to a group of UEs) that cover the frequency band shared between the UEs in the group can be sent for performing channel estimation over the total shared bandwidth. The length and location of shared frequency domain resources as well as the group common DMRS configuration can be sent via dedicated DCI to each UE or via a group DCI dedicated to the group of UEs. Prior to assigning DFT for a group of UEs, NE can group the UEs based on their measurement reports. For example, UEs that report similar SINR (indicating the range) can be grouped together and served with a single DFT spreading. In examples UEs close to the NE can be grouped in small groups (e.g., shorter DFT spreading comparing to UEs located farther away from NE) since PAPR reduction can be more important for cell edge UEs. In the scenario 400, DFT #1 and DFT #2 are assigned to two near UEs for each, while DFT #3 is assigned for more cell edge UEs to benefit from the long DFT for reducing PAPR.

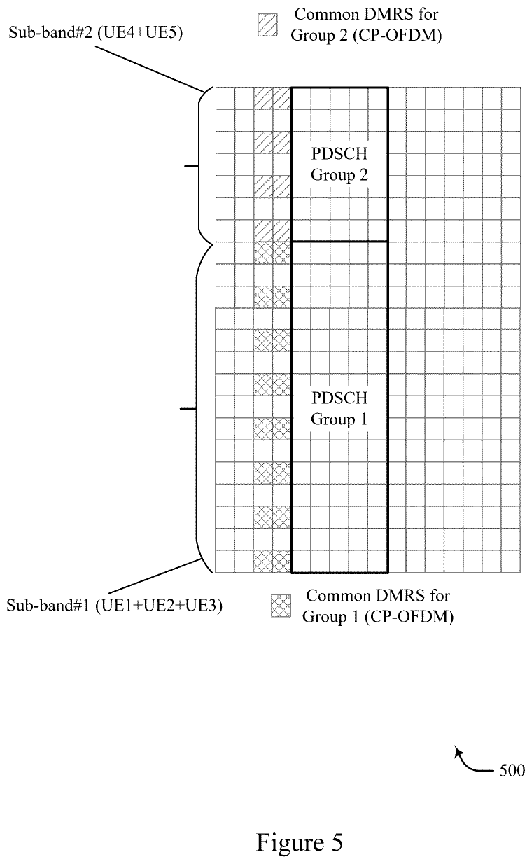

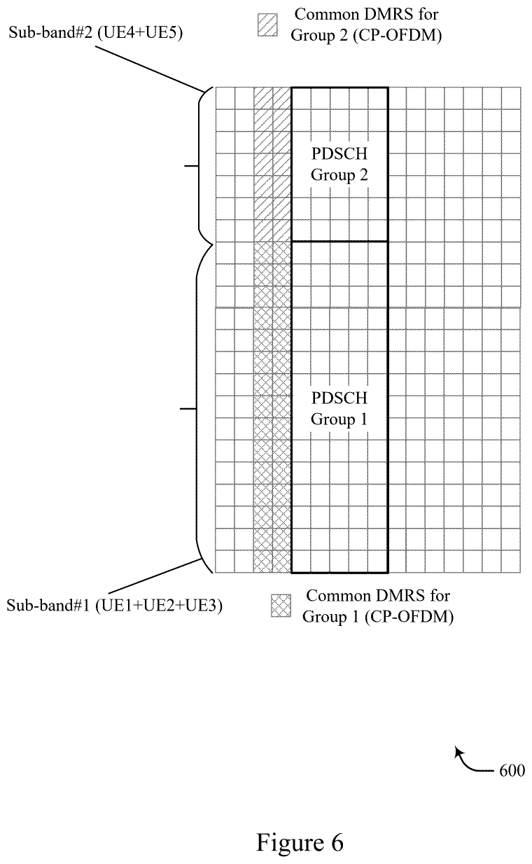

FIGS. 5 and 6 illustrate example scenarios 500, 600 in accordance with aspects of the present disclosure. For instance, in the scenario 500 group DMRS can be sent using CP-OFDM in some symbols within a sub-band group. In the scenario 600, DMRS can be sent using DFT-s-OFDM and mapped to some symbols within a sub-band group. In implementations, a single DFT can be performed on the time domain data of plurality of UEs in DL to generate combined frequency domain resources for the plurality of UEs. These resources can be mapped to the corresponding frequency resource elements prior to IFFT. For instance, a single DFT based DFT-s-OFDM waveform can be applied to a sub-band created using a contiguous group of RBs in the frequency domain where group of UEs is allocated within the sub-band. The physical channels transmitted within the sub-band can be configured for unicast, groupcast, control channel, and data channel transmissions. NE may configure sub-band specific common DMRS for a group of UEs allocated within the DFT/sub-band. The DMRS can be beamformed based on a serving beam of the group and that covers the frequency band shared between the UEs in the group. Group common DMRS configuration can be sent via dedicated DCI to each UE or via a group DCI dedicated to the group of UEs. Type(s) of DMRS allocation, waveform used for DMRS, and the additional DMRS symbols can be indicated to UE via sending in DCI a row index of a pre-defined table. DMRS sequence can be generated as dedicated to the group of UEs and scrambled with group ID, and the group ID can be sent to the group of UEs via group control channel. Common TCI and QCL specific for the group of UEs (e.g., QCLed with SSB or CSI-reference signal (RS) within the sub-band) can be configured to the UEs in the group.

Implementations also enable common sub-band DFT spreading for PDCCH of multiple UEs. For instance, a single common DFT can be performed on the time domain control/CCEs of a plurality of UEs in DL to generate sub-band combined frequency domain resources for the plurality of UEs. In one implementation, the subband specific common CORESET can be configured within the common sub-band and the configuration of common spreading length of CORESET #0 can be same as that of the common subband. In another implementation, one or more PDCCH search spaces within the larger CORESET can be configured within the common subband, implying that the CORSET can be larger compared to the one or more search spaces within the CORESET which can be configured within the common subband and can have common DFT spreading length. The common subband configured with common spreading length for DFT-s-OFDM may contain common DMRS time-frequency location and placement and density of DMRS, can have CORESET within the common subband, can have one or more search spaces within the common subband, and/or can be one or more common CSI-RS resources configured within the common subband. The combined control region of different UEs can be mapped to the corresponding frequency resource elements prior to IFFT, which can enable a reduced PAPR compared to the separate DFTs performed on the CCEs of each scheduled UE. To benefit from sub-band DFT, the plurality of UEs sharing same DFT can be grouped based on the serving beam, e.g., based on their SSB beam or based on their serving beams before the assignment to DFT spreading group. In one implementation, time domain CCEs with the corresponding aggregation level (AL) for each UE can be concatenated to form a search space with a length of DFT, and the DFT is applied on the concatenated CCEs. In another implementation, time domain CCEs with the corresponding AL of UEs can be interleaved prior to DFT spreading. The length and location of shared frequency domain resources can be sent via dedicated RRC message to each UE or via a group RRC dedicated to the group of UEs. Further, group based DMRS for PDCCH can be sent within the search space/control region of the group of UEs.

In implementations, a single common DFT spreading can be applied for both SSB and CORESET #0 in case of frequency domain multiplexing pattern. Additionally or alternatively, NE can switch a UE from one DFT/sub-band group to another DFT/sub-band group based on UE measurements such as UE reported CSI/best CSI beam, reported SINR, and/or other scheduling parameters. Additionally or alternatively, NE can switch one or more UEs in a DFT group to use CP-OFDM instead of DFT-s-OFDM. Switching configuration can be sent to the UE via dedicated DCI, group DCI, or RRC message.

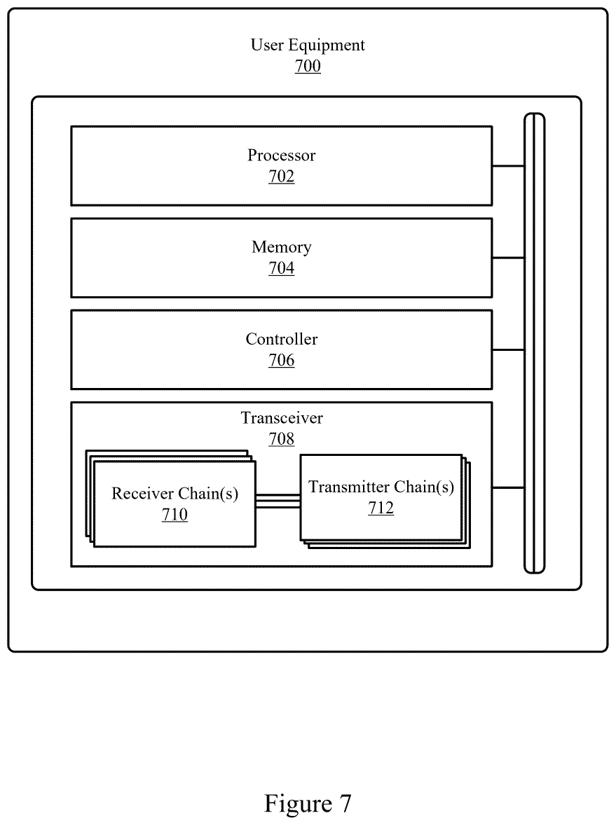

FIG. 7 illustrates an example of a UE 700 in accordance with aspects of the present disclosure. The UE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the UE 700 to perform various functions of the present disclosure.

The memory 704 may include volatile or non-volatile memory. The memory 704 may store computer-readable, computer-executable code including instructions when executed by the processor 702 cause the UE 700 to perform various functions described herein. The code may be stored in a non-transitory computer-readable medium such as the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the UE 700 to perform one or more of the functions described herein (e.g., executing, by the processor 702, instructions stored in the memory 704). For example, the processor 702 may support wireless communication at the UE 700 in accordance with examples as disclosed herein. The UE 700 may be configured to or operable to support a means for receiving signaling including configuration for common DFT spreading length of a DFT-s-OFDM waveform, the common DFT spreading length configured for a common sub-band generated using contiguous frequency domain resource blocks for a group of UEs; and receiving at least one of common channel, control channel, or data channel within the common sub-band using the common DFT spreading length of the DFT-s-OFDM waveform.

Additionally, the UE 700 may be configured to support any one or combination of the configuration includes information of the spreading length and location of frequency resources of the common sub-band; the configuration includes time domain information for time resources for each UE of the group of UEs mapped prior to applying DFT, and wherein the time domain information is indicated by a bit map of time resources or via interleaving information indicating a location of the time domain resources; receiving the configuration including time-frequency resource for transmission to each UE of the group of UEs within the common sub-band via one or more of dedicated DCI, via group DCI, or via RRC, or a combination thereof; the configuration includes information of one or more of a group common DMRS type, a DMRS waveform, or DMRS location within the common sub-band; receiving the configuration via one or more of a row index of a table sent via dedicated DCI, via group DCI, or via RRC; the configuration includes information of the length and location of frequency resources of the common sub-band.

Additionally, or alternatively, the UE 700 may support at least one memory (e.g., the memory 704) and at least one processor (e.g., the processor 702) coupled with the at least one memory and configured to cause the UE to receive signaling including configuration for common DFT spreading length of a DFT-s-OFDM waveform, the common DFT spreading length configured for a common sub-band generated using contiguous frequency domain resource blocks for a group of UEs; and receive at least one of common channel, control channel, or data channel within the common sub-band using the common DFT spreading length of the DFT-s-OFDM waveform.

Additionally, the UE 700 may be configured to support any one or combination of the configuration includes information of the spreading length and location of frequency resources of the common sub-band; the configuration includes time domain information for time resources for each UE of the group of UEs mapped prior to applying DFT, and wherein the time domain information is indicated by a bit map of time resources or via interleaving information indicating a location of the time domain resources; the at least one processor is configured to cause the UE to receive the configuration including time-frequency resource for transmission to each UE of the group of UEs within the common sub-band via one or more of dedicated DCI, via group DCI, or via RRC, or a combination thereof; the configuration includes information of one or more of a group common DMRS type, a DMRS waveform, or DMRS location within the common sub-band; the at least one processor is configured to cause the UE to receive the configuration via one or more of a row index of a table sent via dedicated DCI, via group DCI, or via RRC; the configuration includes information of the length and location of frequency resources of the common sub-band.

The controller 706 may manage input and output signals for the UE 700. The controller 706 may also manage peripherals not integrated into the UE 700. In some implementations, the controller 706 may utilize an operating system such as iOS®, ANDROID®, WINDOWS®, or other operating systems. In some implementations, the controller 706 may be implemented as part of the processor 702.

In some implementations, the UE 700 may include at least one transceiver 708. In some other implementations, the UE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas to receive a signal over the air or wireless medium. The receiver chain 710 may include at least one amplifier (e.g., a low-noise amplifier (LNA)) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or QAM. The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

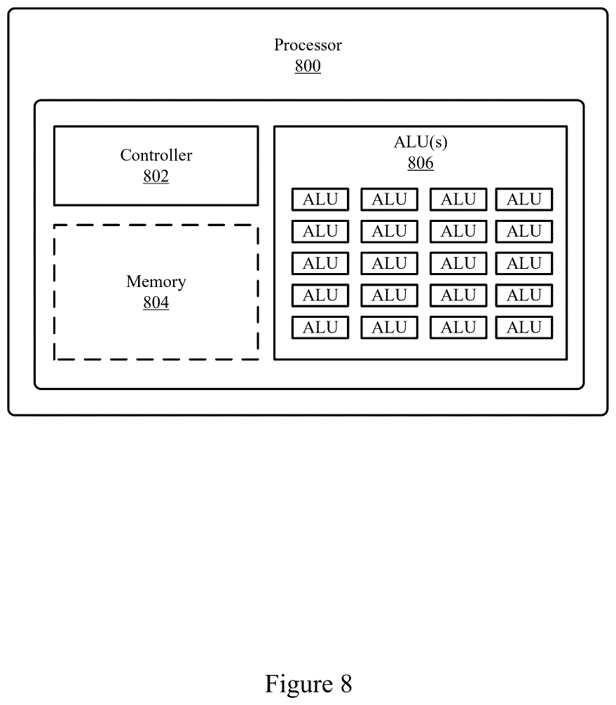

FIG. 8 illustrates an example of a processor 800 in accordance with aspects of the present disclosure. The processor 800 may be an example of a processor configured to perform various operations in accordance with examples as described herein. The processor 800 may include a controller 802 configured to perform various operations in accordance with examples as described herein. The processor 800 may optionally include at least one memory 804, which may be, for example, an L1/L2/L3 cache. Additionally, or alternatively, the processor 800 may optionally include one or more arithmetic-logic units (ALUs) 806. One or more of these components may be in electronic communication or otherwise coupled (e.g., operatively, communicatively, functionally, electronically, electrically) via one or more interfaces (e.g., buses).

The processor 800 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 800) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 802 may be configured to manage and coordinate various operations (e.g., signaling, receiving, obtaining, retrieving, transmitting, outputting, forwarding, storing, determining, identifying, accessing, writing, reading) of the processor 800 to cause the processor 800 to support various operations in accordance with examples as described herein. For example, the controller 802 may operate as a control unit of the processor 800, generating control signals that manage the operation of various components of the processor 800. These control signals include enabling or disabling functional units, selecting data paths, initiating memory access, and coordinating timing of operations.

The controller 802 may be configured to fetch (e.g., obtain, retrieve, receive) instructions from the memory 804 and determine subsequent instruction(s) to be executed to cause the processor 800 to support various operations in accordance with examples as described herein. The controller 802 may be configured to track memory addresses of instructions associated with the memory 804. The controller 802 may be configured to decode instructions to determine the operation to be performed and the operands involved. For example, the controller 802 may be configured to interpret the instruction and determine control signals to be output to other components of the processor 800 to cause the processor 800 to support various operations in accordance with examples as described herein. Additionally, or alternatively, the controller 802 may be configured to manage flow of data within the processor 800. The controller 802 may be configured to control transfer of data between registers, ALUs 806, and other functional units of the processor 800.

The memory 804 may include one or more caches (e.g., memory local to or included in the processor 800 or other memory, such as RAM, ROM, DRAM, SDRAM, SRAM, MRAM, flash memory, etc. In some implementations, the memory 804 may reside within or on a processor chipset (e.g., local to the processor 800). In some other implementations, the memory 804 may reside external to the processor chipset (e.g., remote to the processor 800).

The memory 804 may store computer-readable, computer-executable code including instructions that, when executed by the processor 800, cause the processor 800 to perform various functions described herein. The code may be stored in a non-transitory computer-readable medium such as system memory or another type of memory. The controller 802 and/or the processor 800 may be configured to execute computer-readable instructions stored in the memory 804 to cause the processor 800 to perform various functions. For example, the processor 800 and/or the controller 802 may be coupled with or to the memory 804, the processor 800, and the controller 802, and may be configured to perform various functions described herein. In some examples, the processor 800 may include multiple processors and the memory 804 may include multiple memories. One or more of the multiple processors may be coupled with one or more of the multiple memories, which may, individually or collectively, be configured to perform various functions herein.

The one or more ALUs 806 may be configured to support various operations in accordance with examples as described herein. In some implementations, the one or more ALUs 806 may reside within or on a processor chipset (e.g., the processor 800). In some other implementations, the one or more ALUs 806 may reside external to the processor chipset (e.g., the processor 800). One or more ALUs 806 may perform one or more computations such as addition, subtraction, multiplication, and division on data. For example, one or more ALUs 806 may receive input operands and an operation code, which determines an operation to be executed. One or more ALUs 806 may be configured with a variety of logical and arithmetic circuits, including adders, subtractors, shifters, and logic gates, to process and manipulate the data according to the operation. Additionally, or alternatively, the one or more ALUs 806 may support logical operations such as AND, OR, exclusive-OR (XOR), not-OR (NOR), and not-AND (NAND), enabling the one or more ALUs 806 to handle conditional operations, comparisons, and bitwise operations.

The processor 800 may support wireless communication in accordance with examples as disclosed herein. The processor 800 may be configured to or operable to support at least one controller (e.g., the controller 802) coupled with at least one memory (e.g., the memory 804) and configured to cause the processor to receive signaling including configuration for common DFT spreading length of a DFT-s-OFDM waveform, the common DFT spreading length configured for a common sub-band generated using contiguous frequency domain resource blocks for a group of UEs; and receive at least one of common channel, control channel, or data channel within the common sub-band using the common DFT spreading length of the DFT-s-OFDM waveform.

Additionally, the processor 800 may be configured to or operable to support any one or combination of the configuration includes information of the spreading length and location of frequency resources of the common sub-band; the configuration includes time domain information for time resources for each UE of the group of UEs mapped prior to applying DFT, and wherein the time domain information is indicated by a bit map of time resources or via interleaving information indicating a location of the time domain resources; the at least one controller is configured to cause the processor to receive the configuration including time-frequency resource for transmission to each UE of the group of UEs within the common sub-band via one or more of dedicated DCI, via group DCI, or via RRC, or a combination thereof; the configuration includes information of one or more of a group common DMRS type, a DMRS waveform, or DMRS location within the common sub-band; the at least one controller is configured to cause the processor to receive the configuration via one or more of a row index of a table sent via dedicated DCI, via group DCI, or via RRC; the configuration includes information of the length and location of frequency resources of the common sub-band.

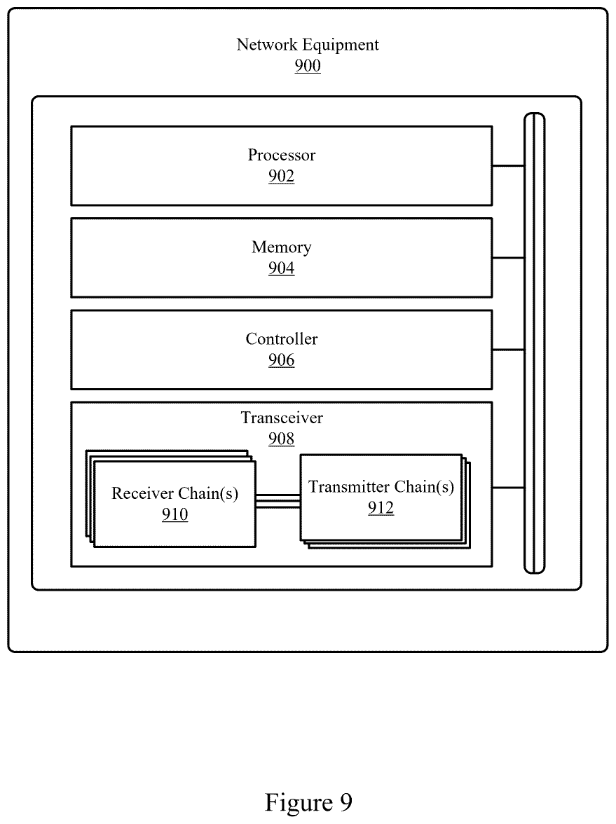

FIG. 9 illustrates an example of a NE 900 in accordance with aspects of the present disclosure. The NE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 902 may include an intelligent hardware device (e.g., a general-purpose processor, a DSP, a CPU, an ASIC, an FPGA, or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the NE 900 to perform various functions of the present disclosure.

The memory 904 may include volatile or non-volatile memory. The memory 904 may store computer-readable, computer-executable code including instructions when executed by the processor 902 cause the NE 900 to perform various functions described herein. The code may be stored in a non-transitory computer-readable medium such as the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the NE 900 to perform one or more of the functions described herein (e.g., executing, by the processor 902, instructions stored in the memory 904). For example, the processor 902 may support wireless communication at the NE 900 in accordance with examples as disclosed herein. The NE 900 may be configured to or operable to support a means for transmitting signaling comprising a configuration for a common DFT spreading length of a DFT-s-OFDM waveform, the common DFT spreading length configured for a common sub-band generated using contiguous frequency domain resource blocks for a group of UEs; and transmitting a DFT-s-OFDM waveform over at least one of common channel, control channel, or data channel within the common sub-band and according to the common DFT spreading length of the DFT-s-OFDM waveform.

Additionally, the NE 900 may be configured to or operable to support any one or combination of determining the common DFT spreading length of the DFT-s-OFDM waveform based on one or more of an PAPR gain for the common sub-band used in a connected mode for the group of UEs, or a SSB or CORESET #0 bandwidth for an initial sub-band used for initial access; determining a number of sub-bands within a BWP or a carrier and based at least in part on the BWP or a carrier total bandwidth and the PAPR gain; further including determining a grouping respective configuration applicable for the group of UEs to be served within the common sub-band and the common DFT spreading length of the DFT-s-OFDM waveform based at least in part on serving beams or SSB beams of the group of UEs; determining the configuration and the group of UEs to be served with the common sub-band and the common DFT spreading length of the DFT-s-OFDM waveform based at least in part on beam coverage of the network equipment or a proximity of each UE to the network equipment; the configuration is semi-static and identifies the common sub-band containing common spreading length and location of frequency resources of the common sub-band.

Additionally, the NE 900 may be configured to or operable to support any one or combination of the configuration includes time domain information for time resources for each UE of the group of UEs mapped prior to applying DFT, and wherein the time domain information is indicated by a bit map of time resources or via interleaving information indicating a location of the time domain resources; signaling the configuration including time-frequency resource for transmission to each UE of the group of UEs within the common sub-band via one or more of dedicated DCI, via group DCI, or via RRC, or a combination thereof; the configuration includes information of one or more of a group common DMRS type, a DMRS waveform, or DMRS location within the common sub-band; further including signaling the configuration via one or more of a row index of a table sent via dedicated DCI to each UE of the group of UEs, via group DCI, or via RRC; the configuration includes information of the length and location of frequency resources of the common sub-band.

Additionally, or alternatively, the NE 900 may support at least one memory (e.g., the memory 904) and at least one processor (e.g., the processor 902) coupled with the at least one memory and configured to cause the NE to transmit signaling comprising a configuration for a common DFT spreading length of a DFT-s-OFDM waveform, the common DFT spreading length configured for a common sub-band generated using contiguous frequency domain resource blocks for a group of UEs; and transmit a DFT-s-OFDM waveform over at least one of common channel, control channel, or data channel within the common sub-band and according to the common DFT spreading length of the DFT-s-OFDM waveform.

Additionally, the NE 900 may be configured to support any one or combination of the at least one processor is configured to cause the network equipment to determine the common DFT spreading length of the DFT-s-OFDM waveform based on one or more of an PAPR gain for the common sub-band used in a connected mode for the group of UEs, or a SSB or CORESET #0 bandwidth for an initial sub-band used for initial access; the at least one processor is configured to cause the network equipment to determine a number of sub-bands within a BWP or a carrier and based at least in part on the BWP or a carrier total bandwidth and the PAPR gain; the at least one processor is configured to cause the network equipment to determine a grouping respective configuration applicable for the group of UEs to be served within the common sub-band and the common DFT spreading length of the DFT-s-OFDM waveform based at least in part on serving beams or SSB beams of the group of UEs; the at least one processor is configured to cause the network equipment to determine the configuration and the group of UEs to be served with the common sub-band and the common DFT spreading length of the DFT-s-OFDM waveform based at least in part on beam coverage of the network equipment or a proximity of each UE to the network equipment; the configuration is semi-static and identifies the common sub-band containing common spreading length and location of frequency resources of the common sub-band.

Additionally, the NE 900 may be configured to support any one or combination of the configuration includes time domain information for time resources for each UE of the group of UEs mapped prior to applying DFT, and wherein the time domain information is indicated by a bit map of time resources or via interleaving information indicating a location of the time domain resources; the at least one processor is configured to cause the network equipment to signal the configuration including time-frequency resource for transmission to each UE of the group of UEs within the common sub-band via one or more of dedicated DCI, via group DCI, or via RRC, or a combination thereof; the configuration includes information of one or more of a group common DMRS type, a DMRS waveform, or DMRS location within the common sub-band; the at least one processor is configured to cause the network equipment to signal the configuration via one or more of a row index of a table sent via dedicated DCI to each UE of the group of UEs, via group DCI, or via RRC; the configuration includes information of the length and location of frequency resources of the common sub-band.

The controller 906 may manage input and output signals for the NE 900. The controller 906 may also manage peripherals not integrated into the NE 900. In some implementations, the controller 906 may utilize an operating system such as iOS®, ANDROID®, WINDOWS®, or other operating systems. In some implementations, the controller 906 may be implemented as part of the processor 902.

In some implementations, the NE 900 may include at least one transceiver 908. In some other implementations, the NE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas to receive a signal over the air or wireless medium. The receiver chain 910 may include at least one amplifier (e.g., a low-noise amplifier (LNA)) configured to amplify the received signal. The receiver chain 910 may include at least one demodulator configured to demodulate the receive signal and obtain the transmitted data by reversing the modulation technique applied during transmission of the signal. The receiver chain 910 may include at least one decoder for decoding the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or QAM. The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

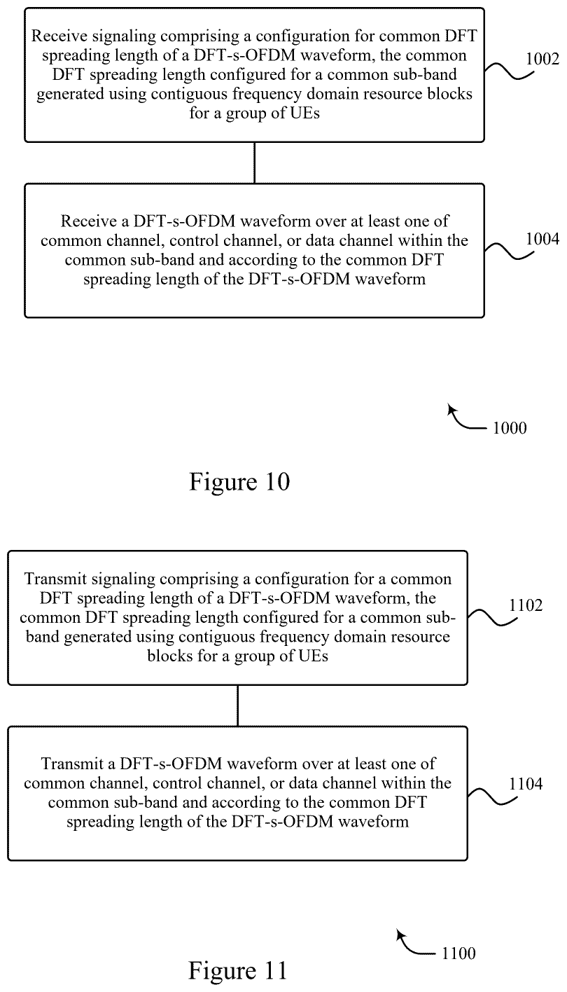

FIG. 10 illustrates a flowchart of a method 1000 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1002, the method may include receiving signaling comprising a configuration for common DFT spreading length of a DFT-s-OFDM waveform, the common DFT spreading length configured for a common sub-band generated using contiguous frequency domain resource blocks for a group of UEs. The operations of 1002 may be performed in accordance with examples as described herein. In some implementations, aspects of the operations of 1002 may be performed by a UE as described with reference to FIG. 7.

At 1004, the method may include receiving a DFT-s-OFDM waveform over at least one of common channel, control channel, or data channel within the common sub-band and according to the common DFT spreading length of the DFT-s-OFDM waveform. The operations of 1004 may be performed in accordance with examples as described herein. In some implementations, aspects of the operations of 1004 may be performed by a UE as described with reference to FIG. 7.

FIG. 11 illustrates a flowchart of a method 1100 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1102, the method may include transmitting signaling comprising a configuration for a common DFT spreading length of a DFT-s-OFDM waveform, the common DFT spreading length configured for a common sub-band generated using contiguous frequency domain resource blocks for a group of UEs. The operations of 1102 may be performed in accordance with examples as described herein. In some implementations, aspects of the operations of 1102 may be performed by a NE as described with reference to FIG. 9.

At 1104, the method may include transmitting a DFT-s-OFDM waveform over at least one of common channel, control channel, or data channel within the common sub-band and according to the common DFT spreading length of the DFT-s-OFDM waveform. The operations of 1104 may be performed in accordance with examples as described herein. In some implementations, aspects of the operations of 1104 may be performed by a NE as described with reference to FIG. 9.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network equipment for wireless communication, comprising:
at least one memory; and
at least one processor coupled with the at least one memory and configured to cause the network equipment to:
transmit signaling comprising a configuration for a common Discrete Fourier Transform (DFT) spreading length of a DFT-s-OFDM waveform, the common DFT spreading length configured for a common sub-band generated using contiguous frequency domain resource blocks for a group of user equipment (UEs); and
transmit a DFT-s-OFDM waveform over at least one of common channel, control channel, or data channel within the common sub-band and according to the common DFT spreading length of the DFT-s-OFDM waveform.

2. The network equipment of claim 1, wherein the at least one processor is configured to cause the network equipment to determine the common DFT spreading length of the DFT-s-OFDM waveform based on one or more of a peak to average power ratio (PAPR) gain for the common sub-band used in a connected mode for the group of UEs, or a synchronization signal block (SSB) or control resource set (CORESET) #0 bandwidth for an initial sub-band used for initial access.

3. The network equipment of claim 2, wherein the at least one processor is configured to cause the network equipment to determine a number of sub-bands within a bandwidth part (BWP) or a carrier and based at least in part on the BWP or a carrier total bandwidth and the PAPR gain.

4. The network equipment of claim 1, wherein the at least one processor is configured to cause the network equipment to determine a grouping respective configuration applicable for the group of UEs to be served within the common sub-band and the common DFT spreading length of the DFT-s-OFDM waveform based at least in part on serving beams or synchronization signal block (SSB) beams of the group of UEs.

5. The network equipment of claim 1, wherein the at least one processor is configured to cause the network equipment to determine the configuration and the group of UEs to be served with the common sub-band and the common DFT spreading length of the DFT-s-OFDM waveform based at least in part on beam coverage of the network equipment or a proximity of each UE to the network equipment.

6. The network equipment of claim 1, wherein the configuration is semi-static and identifies the common sub-band containing common spreading length and location of frequency resources of the common sub-band.

7. The network equipment of claim 1, wherein the configuration comprises time domain information for time resources for each UE of the group of UEs mapped prior to applying DFT, and wherein the time domain information is indicated by a bit map of time resources or via interleaving information indicating a location of the time domain resources.

8. The network equipment of claim 1, wherein the at least one processor is configured to cause the network equipment to signal the configuration including time-frequency resource for transmission to each UE of the group of UEs within the common sub-band via one or more of dedicated DCI, via group downlink control information (DCI), or via radio resource control (RRC), or a combination thereof.

9. The network equipment of claim 1, wherein the configuration comprises information of one or more of a group common demodulation reference signal (DMRS) type, a DMRS waveform, or DMRS location within the common sub-band.

10. The network equipment of claim 1, wherein the at least one processor is configured to cause the network equipment to signal the configuration via one or more of a row index of a table sent via dedicated downlink control information (DCI) to each UE of the group of UEs, via group DCI, or via radio resource control (RRC).

11. The network equipment of claim 1, wherein the configuration comprises information of the length and location of frequency resources of the common sub-band.

12. A user equipment (UE) for wireless communication, comprising:
at least one memory; and
at least one processor coupled with the at least one memory and configured to cause the UE to:
receive signaling comprising a configuration for common Discrete Fourier Transform (DFT) spreading length of a DFT-s-OFDM waveform, the common DFT spreading length configured for a common sub-band generated using contiguous frequency domain resource blocks for a group of UEs; and
receive a DFT-s-OFDM waveform over at least one of common channel, control channel, or data channel within the common sub-band and according to the common DFT spreading length of the DFT-s-OFDM waveform.

13. The UE of claim 12, wherein the configuration comprises information of the spreading length and location of frequency resources of the common sub-band.

14. The UE of claim 12, wherein the configuration comprises time domain information for time resources for each UE of the group of UEs mapped prior to applying DFT, and wherein the time domain information is indicated by a bit map of time resources or via interleaving information indicating a location of the time domain resources.

15. The UE of claim 12, wherein the at least one processor is configured to cause the UE to receive the configuration including time-frequency resource for transmission to each UE of the group of UEs within the common sub-band via one or more of dedicated DCI, via group downlink control information (DCI), or via radio resource control (RRC), or a combination thereof.

16. The UE of claim 12, wherein the configuration comprises information of one or more of a group common demodulation reference signal (DMRS) type, a DMRS waveform, or DMRS location within the common sub-band.

17. The UE of claim 12, wherein the at least one processor is configured to cause the UE to receive the configuration via one or more of a row index of a table sent via dedicated downlink control information (DCI), via group DCI, or via radio resource control (RRC).

18. The UE of claim 12, wherein the configuration comprises information of the length and location of frequency resources of the common sub-band.

19. A processor for wireless communication, comprising:
at least one controller coupled with at least one memory and configured to cause the processor to:
receive signaling comprising a configuration for common Discrete Fourier Transform (DFT) spreading length of a DFT-s-OFDM waveform, the common DFT spreading length configured for a common sub-band generated using contiguous frequency domain resource blocks for a group of user equipment (UE); and
receive a DFT-s-OFDM waveform over at least one of common channel, control channel, or data channel within the common sub-band and according to the common DFT spreading length of the DFT-s-OFDM waveform.

20. A method performed by a user equipment (UE), the method comprising:
receiving signaling comprising a configuration for common Discrete Fourier Transform (DFT) spreading length of a DFT-s-OFDM waveform, the common DFT spreading length configured for a common sub-band generated using contiguous frequency domain resource blocks for a group of UEs; and
receive a DFT-s-OFDM waveform over at least one of common channel, control channel, or data channel within the common sub-band and according to the common DFT spreading length of the DFT-s-OFDM waveform.
